(19) United States
(12) Patent Application Publication
(10) Pub. No.: US 2012/0299846 A1
(43) Pub. Date: Nov. 29, 2012

(54) ELECTRONIC APPARATUS AND OPERATION SUPPORT METHOD

(76) Inventor: Kyohei Matsuda, Ome-shi (JP)

(21) Appl. No.: 13/402,693

(22) Filed: Feb. 22, 2012

(30) Foreign Application Priority Data
May 27, 2011 (JP) 2011-119291

(51) Int. Cl. G06F 3/041

(52) U.S. Cl. 345/173

(57) ABSTRACT

According to one embodiment, an electronic apparatus which includes a touch-screen display including a touch panel and a first display, and is connectable to a second display, includes an operation screen switching module and an input control module. The operation screen switching module sets either the first display or the second display to be an operation target screen operated by an input using the touch panel. The input control module operates the second display in accordance with the input using the touch panel when the second display is set to be the operation target screen.

### CROSS-REFERENCE TO RELATED APPLICATIONS

This application is based upon and claims the benefit of priority from prior Japanese Patent Application No. 2011-119291, filed May 27, 2011, the entire contents of which are incorporated herein by reference.

### FIELD

Embodiments described herein relate generally to an electronic apparatus including a touch-screen display, and an operation support method applied to the apparatus.

### BACKGROUND

Touch-screen display device, which enables an intuitive operation of objects in images displayed on a screen by touching the screen, has been gaining in popularity. For example, by touching an object, such as an icon, a button, a scroll bar, an image or a window, which is displayed on the screen, the user can execute a function which is associated with the touched object. Such touch-screen display device is used in, for example, portable video game machines, smartphones, tablet-type personal computers (PC), etc.

It is also possible to realize a large-sized touch-screen display which can be visually recognized by an audience who gathers in a wide place such as a conference hall or a lecture room, and which can be intuitively operated by a presenter (user). On such a large-sized touch-screen display, the hand may not reach an upper part of the touch-screen display or the presenter may need to move to the left or right end of the touch-screen display, so it is possible that a great labor is required for a touch operation. To cope with this problem, there has been proposed a technique of operating the touch-screen display by reducing in size the image of a predetermined area displayed on the touch-screen display, displaying the reduced image on another small screen area in the touch-screen display, and substituting a touch operation on the small screen area for a touch operation on the predetermined area. Thereby, when the user uses the large-sized touch-screen display, the user can easily operate an object, which is distant from the position where the user currently operates.

In the meantime, in some cases, a first display including a touch panel and a second display including no touch panel are connected to a computer. In such cases, the computer can display the same video image on the first display and the second display at the same time (“clone display”), or can display different video images on the first display and second display at the same time (“extended display”). In the extended display, the user can use a plurality of displays as if they were a single display.

However, while an object displayed on the screen of the first display (touch-screen display) can be intuitively operated by using the touch panel, such an intuitive operation using a touch panel cannot be executed on the second display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an example of the external appearance of an electronic apparatus according to an embodiment.

FIG. 2 is an exemplary block diagram illustrating an example of the structure of the electronic apparatus of the embodiment.

FIG. 3 is an exemplary block diagram illustrating an example of the structure of an operation support program which is executed by the electronic apparatus of the embodiment.

FIG. 4 illustrates an example of a screen which is displayed by the electronic apparatus of the embodiment.

FIG. 5 illustrates another example of the screen which is displayed by the electronic apparatus of the embodiment.

FIG. 6 illustrates still another example of the screen which is displayed by the electronic apparatus of the embodiment.

FIG. 7 illustrates an example of a transition of the screen which is displayed by the electronic apparatus of the embodiment.

FIG. 8 is an exemplary flowchart illustrating an example of the procedure of a screen image display control process which is executed by the electronic apparatus of the embodiment.

FIG. 9 is an exemplary flowchart illustrating an example of the procedure of a touch input control process which is executed by the electronic apparatus of the embodiment.

### DETAILED DESCRIPTION

Various embodiments will be described hereinafter with reference to the accompanying drawings.

In general, according to one embodiment, an electronic apparatus which includes a touch-screen display including a touch panel and a first display, and is connectable to a second display, includes an operation screen switching module and an input control module. The operation screen switching module sets either the first display or the second display to be an operation target screen operated by an input using the touch panel. The input control module operates the second display in accordance with the input using the touch panel when the second display is set to be the operation target screen.

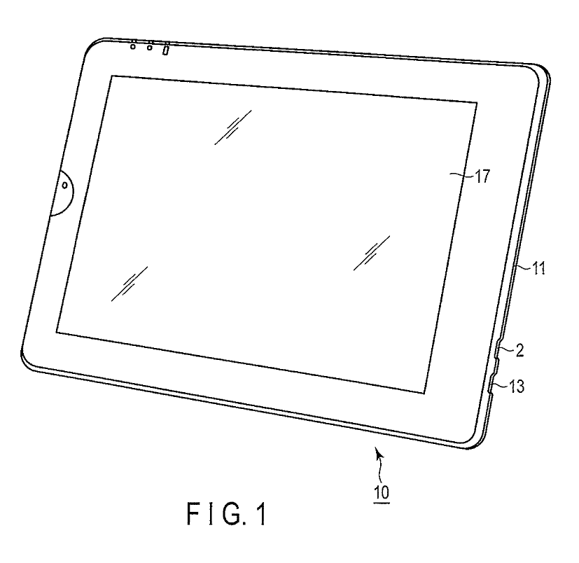

FIG. 1 is a perspective view illustrating the external appearance of an electronic apparatus according to an embodiment. This electronic apparatus is realized, for example, as a tablet-type personal computer (PC) 10. In addition, the electronic apparatus may be realized as a smartphone, a PDA, a notebook-type PC, etc. As shown in FIG. 1, the computer 10 includes a computer main body 11 and a touch-screen display 17.

The computer main body 11 has a thin box-shaped housing. A liquid crystal display (LCD) 17A and a touch panel 17B are built in the touch-screen display 17. The touch panel 17B is provided so as to cover the screen of the LCD 17A. The touch-screen display 17 is attached to the computer main body 11 in such a manner that the touch-screen display 17 is laid over the top surface of the computer main body 11.

A power button 14 for powering on/off the computer 10, a volume control button, a memory card slot, etc. are disposed on an upper side surface of the computer main body 11. A speaker, etc. are disposed on a lower side surface of the computer main body 11. A right side surface of the computer main body 11 is provided with a USB connector 13 for connection to a USB cable or a USB device of, e.g. the universal serial bus (USB) 2.0 standard, and an external display connection terminal 2 supporting the high-definition multimedia interface (HDMI) standard. This external display connection terminal 2 is used in order to output a digital video signal to an external display.

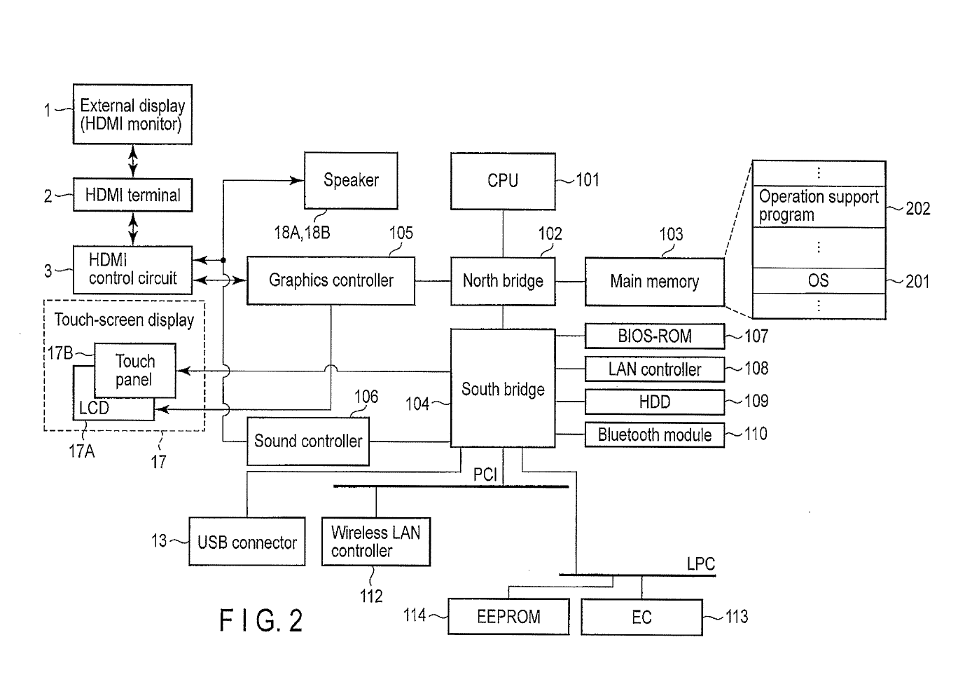

FIG. 2 shows the system configuration of the computer 10.

The computer 10, as shown in FIG. 2, includes a CPU 101, a north bridge 102, a main memory 103, a south bridge 104, a graphics controller 105, a sound controller 106, a BIOS-ROM 107, a LAN controller 108, a hard disk drive (HDD) 109, a Bluetooth® module 110, a wireless LAN controller 112, an embedded controller (EC) 113, an EEPROM 114, and an HDMI control circuit 3.

The CPU 101 is a processor for controlling the operation of the respective components of the computer 10. The CPU 101 executes an operating system (OS) 201, an operation support program 202 and various application programs, which are loaded from the HDD 109 into the main memory 103. The operation support program 202 includes an operation support function for supporting an input operation using the touch-screen display 17. The operation support program 202 controls the input using the touch panel 17B, so that not only the screen displayed on the LCD 17A provided in the touch-screen display 17, but also the screen displayed on an external display device 1 connected via the HDMI terminal 2, can be operated by using the touch panel 17B provided in the touch-screen display device 17.

For example, when the external display device 1 is not connected to the computer 10, the screen displayed on the LCD 17A is operated by an operation using the touch panel 17B. For example, when the external display device 1 is connected to the computer 10, the operation support program 202 executes control so that either the screen displayed on the LCD 17A or the screen displayed on the external display device 1 may be operated by the operation using the touch panel 17B. Thus, when the screen displayed on the external display device 1 is operated by using the touch panel 17B, the operation support program 202 converts a touch input (operation) on the touch panel 17B to an operation on the screen displayed on the external display device 1.

Besides, the CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the graphics controller 105 via, e.g. a PCI EXPRESS serial bus.

The graphics controller 105 is a display controller which controls the LCD 17A that is used as a display monitor of the computer 10. A display signal, which is generated by the graphics controller 105, is sent to the LCD 17A. The LCD 17A displays video, based on the display signal.

The HDMI terminal 2 is the above-described external display connection terminal. The HDMI terminal 2 is capable of sending a non-compressed digital video signal and a digital audio signal to the external display device 1 via a single cable. The HDMI control circuit 3 is an interface for sending a digital video signal to the external display device 1, which is called “HDMI monitor”, via the HDMI terminal 2. In short, the computer 10 can be connected to the external display device 1 via, e.g. the HDMI terminal 2.

The south bridge 104 controls devices on a peripheral component interconnect (PCI) bus and devices on a low pin count (LPC) bus. The south bridge 104 includes an integrated drive electronics (IDE) controller for controlling the HDD 109.

The south bridge 104 includes a USB controller for controlling the touch panel 17B. The touch panel 17B is a pointing device for executing an input on the screen of the LCD 17A. The user can operate a graphical user interface (GUI), or the like, which is displayed on the screen of the LCD 17A, by using the touch panel 17B. For example, by touching a button displayed on the screen, the user can instruct execution of a function corresponding to the button. In addition, the USB controller communicates with an external device, for example, via a cable of the USB 2.0 standard which is connected to the USB connector 13.

The south bridge 104 also has a function of communicating with the sound controller 106. The sound controller 106 is a sound source device and outputs audio data, which is to be played, to the speakers 18A and 18B. The LAN controller 108 is a wired communication device which executes wired communication of, e.g. the IEEE 802.3 standard. The wireless LAN controller 112 is a wireless communication device which executes wireless communication of, e.g. the IEEE 802.11g standard. The Bluetooth module 110 is a communication module which executes Bluetooth communication with an external device.

The EC 113 is a one-chip microcomputer including an embedded controller for power management. The EC 113 has a function of powering on/off the computer 10 in accordance with the user's operation of the power button.

In the meantime, the computer 10 may be configured to include a display with no touch panel, and to be externally connected to a touch-screen display including a touch panel and a display. Besides, the computer 10 may be configured to be externally connected to a touch-screen display including a touch panel and a display, and to a display with no touch panel.

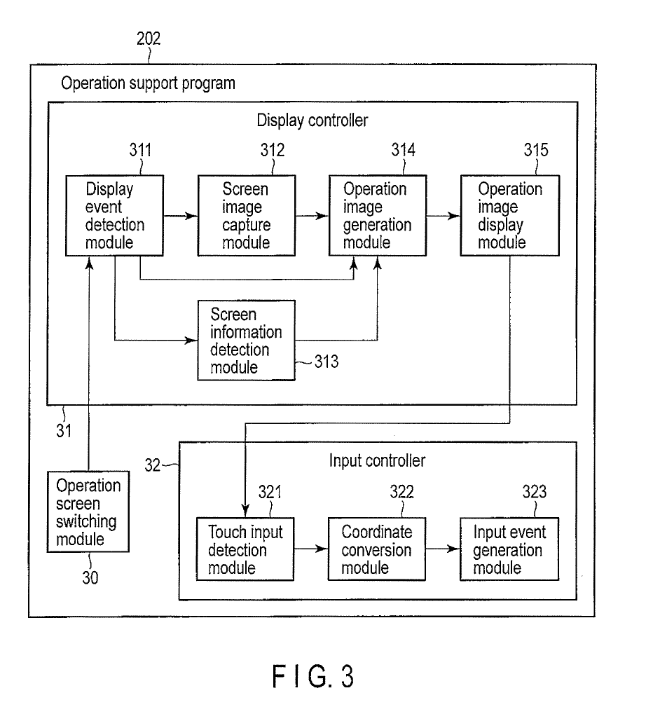

Next, referring to FIG. 3, a functional configuration of the operation support program 202 is described. The operation support program 202 controls the input using the touch panel 17B, so that not only the screen displayed on the LCD 17A provided in the touch-screen display 17, but also the screen displayed on the external display device 1 connected via the HDMI terminal 2, can be operated by using the touch panel 17B provided in the touch-screen display device 17. Various objects, such as an icon, a button, a scroll bar, an image, text or a window, are displayed on the screen of the LCD 17A and on the screen of the external display device 1. The object is a GUI which is a target of operation by the user. The operation support program 202 includes an operation screen switching module 30, a display controller 31 and an input controller 32.

When the touch-screen display 17 and one or more displays are connected to the computer 10 (i.e. when the touch-screen display 17 and one or more displays are available by the computer 10), the operation screen switching module 30 switches the display that is a target of operation (hereinafter also referred to as “operation target screen” or “main screen”), which is to be operated by using the touch panel 178 provided in the touch-screen display 17. The operation screen switching module 30 switches the operation target screen, for example, in accordance with a predetermined operation by the user. For example, when the operation support program 202 is started, or when the external display device 1 is connected to the computer 10, the operation screen switching module 30 sets the screen of the external display device 1 to be the main screen that is the target of operation, and sets the screen of the LCD 17A to be a non-main screen (hereinafter also referred to as “sub-screen”) that is not the target of operation. In addition, for example, when the operation support program 202 is terminated, or when the external display device 1 is disconnected from the computer 10, the operation screen switching module 30 sets the screen of the LCD 17A to be the main screen, and sets the screen of the external display device 1 to be the sub-screen.

The touch input using the touch panel 178 is controlled so as to act on the main screen. Specifically, when the screen of the LCD 17A is set to be the main screen and the screen of the external display device 1 is set to be the sub-screen, the screen of the LCD 17A that is the main screen is operated in accordance with a touch input using the touch panel 17B. The operation of the screen of the LCD 17A by the touch panel 17B may be realized, for example, by a normal operation of the touch-screen display 17. In addition, when the screen of the external display device 1 is set to be the main screen and the screen of the LCD 17A is set to be the sub-screen, the screen of the external display device 1, which is the main screen, is operated in accordance with a touch input using the touch panel 17B. The operation of the screen of the external display device 1 by the touch panel 17B is realized by the display controller 31 and input controller 32 which will be described later.

When the screen of the external display device 1 is set to be the main screen and the screen of the LCD 17A is set to be the sub-screen, the operation screen switching module 30 notifies the display controller 31 (display event detection module 311) that the screen of the external display device 1 has been set to be the main screen.

The display controller 31 controls video which is displayed on the LCD 17A provided in the touch-screen display 17. The display controller 31 includes a display event detection module 311, a screen image capture module 312, a screen information detection module 313, an operation image generation module 314, and an operation image display module 315.

When the display event detection module 311 is notified that the screen of the external display device 1 has been set to be the main screen by the operation screen switching module 30, the display event detection module 311 detects a display event for displaying a screen image (e.g. an image of a desktop screen), which is displayed on the main screen, on the sub-screen. The display event includes an event for displaying the screen image of the main screen on the sub-screen, but also an event for updating the screen image of the main screen which is already displayed on the sub-screen. Thus, the display event detection module 311 detects, as a display event, for example, that a predetermined operation has been executed (e.g. a predetermined button has been pressed), that the screen image displayed on the main screen has been updated, etc. When the display event has been detected by the display event detection module 311, the screen image, which is displayed on the main screen, is displayed on the sub-screen.

When the display event has been detected, the display event detection module 311 notifies the screen image capture module 312 and screen information detection module 313 that the display event has been detected.

Responding to the notification by the display event detection module 311, the screen image capture module 312 captures the image that is rendered on the screen. The captured image includes, for example, an image (also referred to as “main screen image”) which is rendered on the screen of the external display device 1 and an image (also referred to as “sub-screen image”) which is rendered on the screen of the LCD 17A. The screen image capture module 312 outputs the captured image to the operation image generation module 314.

In addition, responding to the notification by the display event detection module 311, the screen information detection module 313 detects the screen size (LX, LY) of the main screen and the screen size (lx, ly) of the sub-screen. For example, the screen information detection module 313 detects the screen size (LX, LY) of the main screen and the screen size (lx, ly) of the sub-screen by using screen information detected by the OS 201 which is indicative of the screen size of the external display device 1 (main screen) and the screen size of the LCD 17A (sub-screen). The screen size indicates the width and height of the screen, which are expressed by, e.g. pixel units. The screen information detection module 313 outputs the detected screen size (LX, LY) of the main screen and the detected screen size (lx, ly) of the sub-screen to the operation image generation module 314.

The operation image generation module 314 extracts the main screen image and sub-screen image from the captured image output by the screen image capture module 312. Then, using the screen size (LX, LY) of the main screen and the screen size (lx, ly) of the sub-screen which have been output by the image information detection module 313, the operation image generation module 314 varies the size (LX, LY) of the main screen image in accordance with the screen size (lx, ly) of the LCD 17A that is the sub-screen, thereby generating an operation image for operating the main screen. For example, when the screen size (LX, LY) of the main screen is larger than the screen size (lx, ly) of the sub-screen, the operation image generation module 314 generates an operation image by reducing the main screen image to the size (lx, ly). Besides, when the screen size (LX, LY) of the main screen is smaller than the screen size (lx, ly) of the sub-screen, the operation image generation module 314 generates an operation image by enlarging the main screen image to the size (lx, ly). Accordingly, the correspondence between coordinates (x, y) on the sub-screen and coordinates (X, Y) on the main screen image is calculated by the following equations:

x=(lx/LX)×X, and

y=(ly/LY)×Y.

The operation image generation module 314 outputs the enlarged/reduced main screen image (operation image) to the operation image display module 315. The main screen image may be enlarged/reduced not only to the screen size of the sub-screen, but also to a size displayable on the sub-screen (i.e. a size smaller than the screen size of the sub-screen).

The operation image display module 315 displays the enlarged/reduced main screen image, which has been output by the operation image generation module 314, on the screen of the LCD 17A that is the sub-screen. The operation image display module 315 renders the main screen image, for example, by superimposing the main screen image on the sub-screen with a predetermined degree of transparency. Since the main screen image is displayed with transparency, the user can distinguishably view the image, which is already displayed on the sub-screen, and the main screen image which is newly displayed for operating the main screen, and therefore the user can easily perform such an operation as a touch input. In the meantime, when the main screen image displayed on the sub-screen is smaller than the screen size of the sub-screen, the operation image display module 315 may display the main screen image on the sub-screen in a non-transparent manner. In addition, when the main screen image is already displayed on the sub-screen (i.e. when an event for updating the main screen image occurs), the operation screen display module 315 updates the main screen image displayed on the sub-screen, by using the main screen image which is output by the operation image generation module 314. The operation image display module 315 notifies the input controller 32 (touch input detection module 321) that the main screen image has been displayed on the sub-screen (or that the screen image displayed on the sub-screen has been updated).

The display event detection module 311 may also detect a display event for displaying, in enlarged scale, a part of the main screen image. The display event detection module 311 detects, as a display event, for example, that the main screen image displayed on the sub-screen has been touched. Then, the display event detection module 311 outputs coordinate information indicative of the touched position to the operation image generation module 314.

The operation image generation module 314 extracts, from the main screen image, a predetermined area including the position indicated by the coordinate information which has been output by the display event detection module 311. Then, the operation image generation module 314 enlarges/reduces the extracted image in accordance with the size of the sub-screen. Specifically, for example, when the coordinate information, which has been output by the display event detection module 311, is indicative of a position within a first window of one or more windows included in the main screen image, the operation image generation module 314 extracts an image (area) including the first window from the main screen image. The extracted image corresponds to, for example, an area including the first window and having an aspect ratio similar to the aspect ratio of the sub-screen. The operation image generation module 314 enlarges/reduces the extracted image in accordance with the size of the sub-screen. The operation image generation module 314 outputs the enlarged/reduced image to the operation image display module 315. Then, the operation image display module 315 updates the screen image displayed on the sub-screen, by using the enlarged/reduced image.

Subsequently, when the screen of the external display device 1 is set to be the main screen (i.e. the screen of the operation target by the touch panel 17B) and the screen of the LCD 17A is set to be the sub-screen, the input controller 32 executes such control that the touch input using the touch panel 17B may act on the main screen. The input controller 32 includes a touch input detection module 321, a coordinate conversion module 322 and an input event generation module 323.

The touch input detection module 321 detects a touch input using the touch panel 17B. The touch input is indicative of an operation of touching the touch panel 17B, and includes a tap input, a drag input and a flick input, as well as a multi-touch input by a simultaneous touch at plural positions. The touch input detection module 321 detects touch input coordinates (x, y) on the sub-screen (i.e. touch panel 17B). Then, the touch input detection module 321 outputs the detected touch input coordinates (x, y) on the sub-screen to the coordinate conversion module 322.

The coordinate conversion module 322 converts the touch input coordinates (x, y), which have been detected by the touch input detection module 321, to coordinates (X, Y) on the main screen (external display device 1). The coordinate conversion module 322 calculates the coordinates (X, Y) on the main screen corresponding to the touch input coordinates (x, y), by using the following equations:

X=(LX/lx)×x, and

Y=(LY/ly)×y.

As has been described above, (LX, LY) indicates the size of the main screen, and (lx, ly) indicates the size of the sub-screen. The coordinate conversion module 322 outputs the calculated coordinates (X, Y) on the main screen to the input event generation module 323.

The input event generation module 323 issues an event indicating that the coordinates (X, Y) have been touched, by using the coordinates (X, Y) on the main screen which have been output by the coordinate conversion module 322. Responding to the issued event, the OS 201 and various programs, which are executed by the computer 10, execute processes corresponding to the event. Thereby, a touch input on the sub-screen (touch panel 17B) is substituted for a touch input on the main screen and acts on the main screen. For example, when the coordinates (X, Y) indicated in the issued event represent a position within a button displayed on the main screen, the function associated with the button is executed. In addition, for example, when the coordinates (X, Y) indicated in the issued event represent a position within a window displayed on the main screen, this window is set in the active state.

By the above-described structure, when the touch-screen display 17 including the touch panel 17B and LCD 17A and the external display device 1, which is not provided with a touch panel, are connected, the object displayed on the external display device 1 can easily be operated by using the touch panel 17B provided in the touch-screen display 17. Specifically, an operation using the touch panel 17B in the touch-screen display 17 can be caused to act on either the LCD 17A or the external display device 1. In addition, when the external display device 1 is set to be the operation target screen (main screen), the screen image displayed on the external display device 1 is displayed on the touch-screen display 17 (LCD 17A), thereby enabling an intuitive operation of the external display device 1 with use of the touch panel 17B.

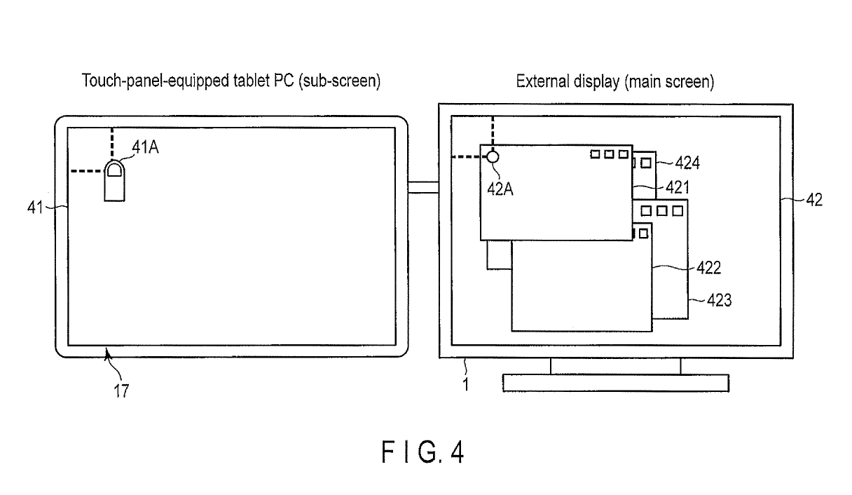

FIGS. 4 to 7 show examples of the screen that is displayed by the computer 10 of the embodiment. In the examples shown in FIGS. 4 to 7, it is assumed that the touch-screen display 17 is built in the computer 10, and the external display device 1 is connected to the computer 10. In addition, it is assumed that the operation screen switching module 30 sets the external display device 1 to be a main screen (operation target screen) 42 which is operated by the touch panel 17B, and sets the LCD 17A in the touch-screen display 17 to be a sub-screen 41 which is not operated by the touch panel 17B. In short, an input by the touch panel 17B is used to operate not the LCD 17A of the sub-screen 41, but the main screen 42 (external display device 1).

In the example shown in FIG. 4, windows 421, 422, 423 and 424 are displayed on the main screen 42. The user executes a touch input on the main screen 42 by touching a point 41A on the sub-screen 41 (touch panel 17B) which corresponds to a point 42A which the user wishes to designate on the main screen 42. For example, while referring to the main screen 42, the user touches the point 41A on the sub-screen 41 which relatively corresponds to the point 42A on the main screen 42.

When the user has touched the point 41A on the sub-screen 41, the touch operation on the point 41A is substituted for a touch input on the point 42A on the main screen 42. Specifically, the coordinates of the point 41A on the sub-screen 41 are converted to the coordinates (point 42A) on the main screen 42. The touch input on the point 41A functions as the touch input on the point 42A on the main screen 42. Thereby, the user can operate the main screen 42 that is the external display device 1 by using the touch panel 17B. Specifically, for example, when the user has touched the point 41A on the sub-screen 41, the window 421 including the point 42A on the main screen 42, which corresponds to the point 41A, is set in the active state.

However, since the user performs an operation on the sub-screen 41 while referring to the main screen 42, it is possible that there arises a touch mistake, such as touching a point on the sub-screen 41 which does not correspond to a point that the user wishes to designate on the main screen 42. Specifically, although the target of touch by the user is the touch-screen display 17 (i.e. the main body of the computer 10), the target of control by the system is the screen of the external display device 1. Hence, a relative operation based on the sensation of the user is required, and it is possible that erroneous pressing of a button, for example, occurs. For example, when a plurality of small objects (e.g. buttons) are displayed on the main screen 42, it is difficult to exactly designate a point on the sub-screen 41, which corresponds to a point which the user wishes to designate on the main screen 42. In addition, for example, it is possible that a button, which is different from a button to be touched, is touched, and an unintended process is executed.

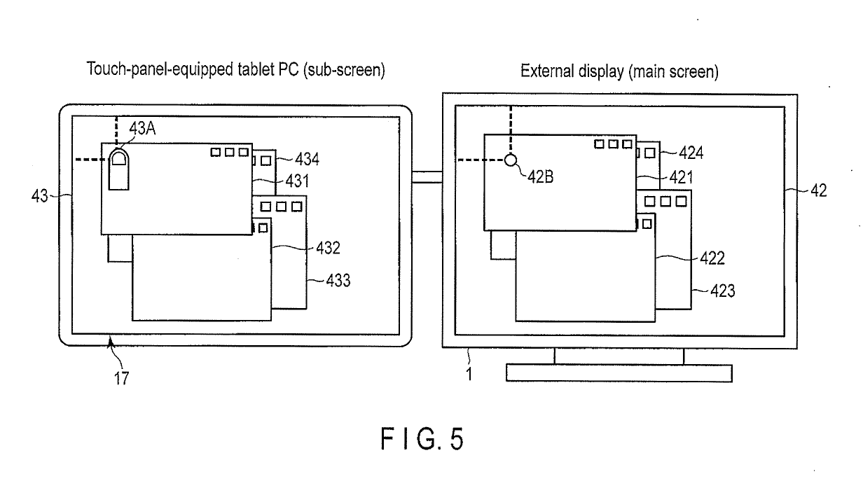

To cope with this problem, as shown in the example shown in FIG. 5, an image, which corresponds to the screen image displayed on the main screen 42, is displayed on a sub-screen 43 in accordance with a predetermined operation. Thereby, the user can perform an operation on the main screen 42 by using the touch panel 17 (i.e. by viewing the sub-screen 43), without viewing the main screen 42 itself. Specifically, since the user can perform not a relative operation, but a direct operation, an erroneous operation, such as erroneous pressing of a button, can be prevented, and the operability by the user can be improved.

In the example shown in FIG. 5, like the example of FIG. 4, windows 421, 422, 423 and 424 are displayed on the main screen 42. On the sub-screen 43, an image, which is an enlarged/reduced image of the screen image of the main screen 42, is displayed with a predetermined degree of transparency. Accordingly, windows 431, 432, 433 and 434 included in the image displayed on the sub-screen 43 correspond to the windows 421, 422, 423 and 424 displayed on the main screen 42, respectively. By touching a point 43A on the sub-screen 43 (touch panel 17B) which corresponds to a point 42B that the user wishes to designate on the main screen 42, the user performs a touch input on the main screen 42. Therefore, the user can intuitively operate the main screen 42 by viewing the image that is a reduced image of the screen image of the main screen 42, without viewing the main screen 42 itself.

When the user has touched the point 43A on the sub-screen 43, the touch operation on the point 43A is substituted for a touch input on the point 428 on the main screen 42. Specifically, the coordinates of the point 43A on the sub-screen 43 are converted to the coordinates (point 428) on the main screen 42. The touch input on the point 43A functions as the touch input on the point 42B on the main screen 42. For example, when the user has touched the point 43A on the sub-screen 43, the window 421 including the point 42B on the main screen 42, which corresponds to the point 43A, is set in the active state.

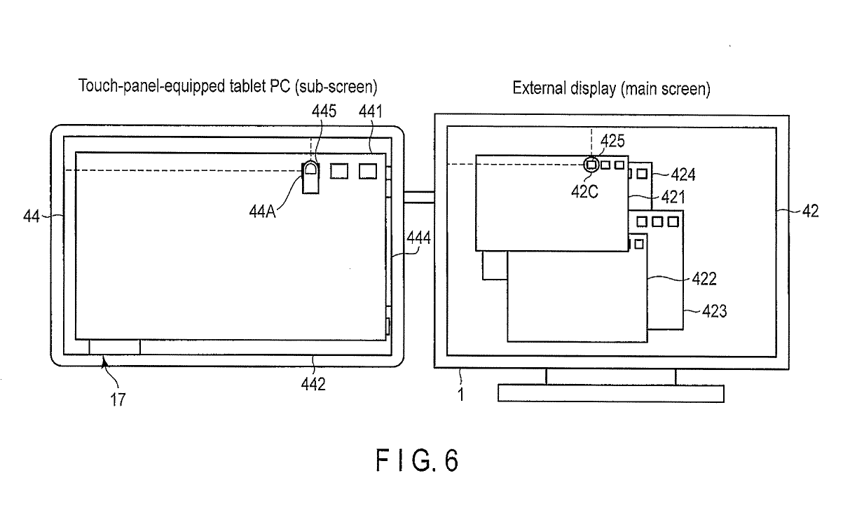

In the example shown in FIG. 6, like the example of FIG. 4, windows 421, 422, 423 and 424 are displayed on the main screen 42. Responding to executing an operation (touch input) of designating a position within the window 421 on the sub-screen 43 shown in FIG. 5, an image which is created by enlarging a part of the main screen image is rendered on a sub-screen 44 with a predetermined transparency. This operation is, for example, an operation for setting the window 421 in the active state. On the sub-screen 44 of FIG. 6, an enlarged image of an area mainly including a window 441, which corresponds to the operated window 421, is rendered. Windows 441, 442 and 444 included in the image displayed on the sub-screen 44 correspond to the windows 421, 422 and 424 displayed on the main screen 42, respectively.

By touching a point 44A on the sub-screen 44 (touch panel 17B) which corresponds to a point 42C that the user wishes to designate on the main screen 42, the user performs a touch input on the main screen 42. The user can operate the main screen 42 by viewing the image in which a part of the main screen image is enlarged, without viewing the main screen 42. In addition, by using the image in which the part of the main screen image is enlarged, a small object, etc. within the screen image can easily be operated.

When the user has touched the point 44A on the sub-screen 44, the touch operation on the point 44A is substituted for a touch input on the point 42C on the main screen 42. Specifically, the coordinates of the point 44A on the sub-screen 44 are converted to the coordinates (point 420) on the main screen 42. The touch input on the point 44A functions as the touch input on the point 42C on the main screen 42. For example, responding to the user's touching a button 445 on the sub-screen 44, the function (process) associated with a button 425 on the main screen 42, which corresponds to the button 445, is executed.

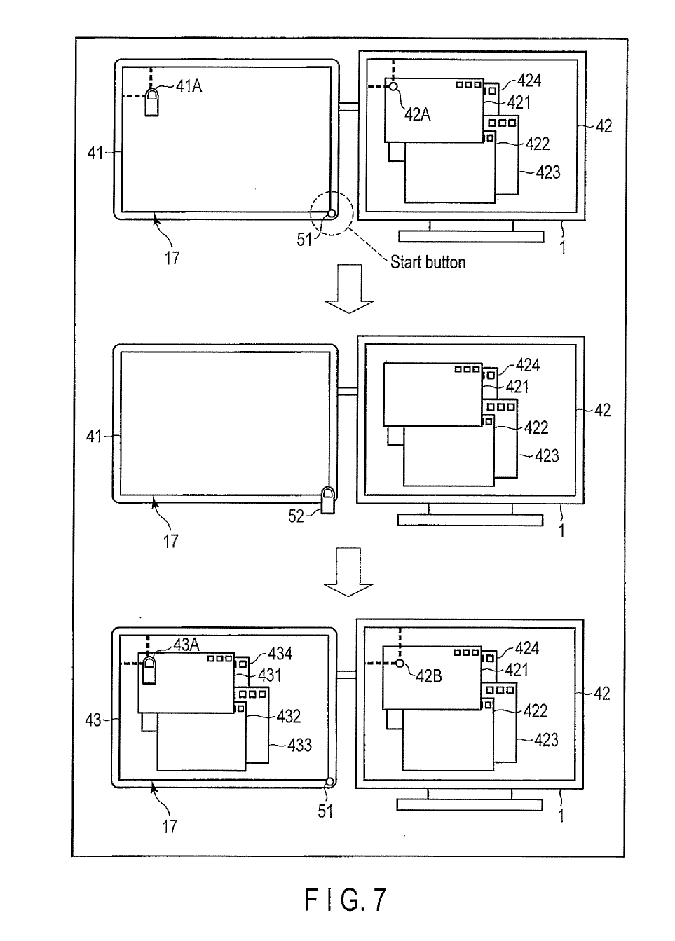

Next, FIG. 7 illustrates an example of a screen transition at a time when a screen image displayed on the main screen 42 is displayed on the sub-screen 41. It is assumed that the computer 10, which includes the touch-screen display 17, is equipped with a start button (hardware button) 51. The start button 51 is a button for instructing that the screen image displayed on the main screen 42 is to be displayed on the sub-screen 41. The pressing of the start button 51 is detected by the display event detection module 311 as a display event for displaying the screen image, which is displayed on the main screen 42, on the sub-screen 41.

As has been described with reference to FIG. 4, the user executes a touch input on the main screen 42 by touching the point 41A on the sub-screen 41 (touch panel 17B). Thereby, the user can operate the main screen 42 that is the external display device 1, by using the touch panel 178.

By pressing the start button 51 by, e.g. a finger 52, the screen image displayed on the main screen 42 is rendered on the sub-screen 43, as described with reference to FIG. 5. Thereby, the user can intuitively operate the main screen 42 by using the touch panel 17B (sub-screen 43), without viewing the main screen 42.

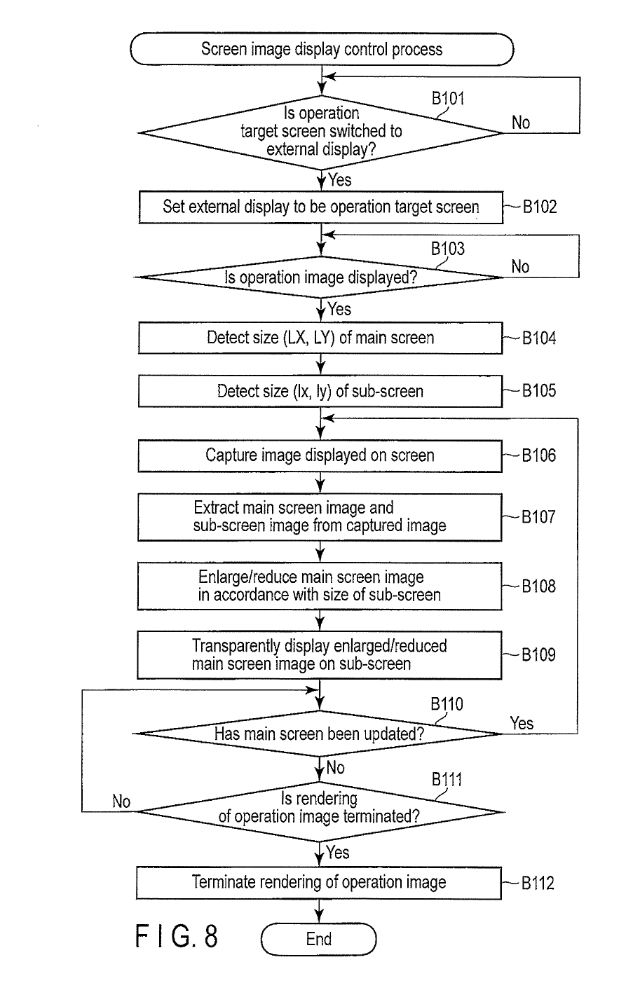

Next, referring to a flowchart illustrated in FIG. 8, a description is given of an example of the procedure of a screen image display control process which is executed by the electronic apparatus 10. It is assumed that at the time of starting the process, the LCD 17A in the touch-screen display 17 is set to be the operation target screen (main screen) which is operated by the touch panel 17B.

To start with, the operation screen switching module 30 determines whether the operation target screen (main screen) is to be switched to the external display device 1 (block B101). For example, when a predetermined operation by the user has been detected, the operation screen switching module 30 switches the operation target screen. For example, the operation target screen is switched from the LCD 17A to the external display device 1, responding to the fact that the operation support program 202 has been started or that the external display device 1 has been connected to the computer 10. When the operation target screen is not switched to the external display device 1 (NO in block B101), the process returns to block B101, and it is determined once again whether the operation target screen is to be switched to the external display device 1. When the operation target screen is switched to the external display device 1 (YES in block B101), the operation screen switching module 30 sets the external display device 1 to be the operation target screen (block B102). In addition, the operation screen switching module 30 sets the LCD 17A to be the screen (sub-screen) that is not the operation target.

Subsequently, the display event detection module 311 determines whether an operation image for supporting the operation of the operation target screen is to be displayed on the LCD 17A (block B103). For example, the pressing of the button 51 for displaying the operation image on the LCD 17A has been detected, the operation image is displayed on the LCD 17A. When the operation image is not displayed on the LCD 17A (NO in block B103), the display event detection module 311 returns to block B103 and determines once again whether the operation screen is to be displayed on the LCD 17A.

If the operation image is to be displayed on the LCD 17A (YES in block B103), the screen information detection module 313 detects the screen size (LX, LY) of the external display device 1 that is the operation target screen (main screen) (block B104). Then, the screen information detection module 313 detects the screen size (lx, ly) of the LCD 17A that is the sub-screen (block B105).

Then, the screen image capture module 312 captures the image which is rendered on the screen (block B106). The captured image includes, for example, an image (main screen image) which is rendered on the screen of the external display device 1 and an image (sub-screen image) which is rendered on the screen of the LCD 17A. The operation image generation module 314 extracts the main screen image and sub-screen image from the captured image (block B107). Then, the operation image generation module 314 enlarges/reduces the main screen image in accordance with the screen size of the LCD 17A that is the sub-screen. For example, if the screen size (LX, LY) of the main screen is larger than the screen size (lx, ly) of the sub-screen 17A, the operation image generation module 314 reduces the main screen image to the size (lx, ly). Besides, if the screen size (LX, LY) of the main screen is smaller than the screen size (lx, ly) of the sub-screen 17A, the operation image generation module 314 enlarges the main screen image to the size (lx, ly). The operation image display module 315 renders the enlarged/reduced main screen image (operation image) on the screen of the LCD 17A that is the sub-screen in a transparent display manner (block B109).

Subsequently, the display event detection module 311 determines whether the image rendered on the main screen has been updated (block B110). The image rendered on the main screen is updated, for example, in response to an operation by the user or the occurrence of various events. When the image rendered on the main screen has been updated (YES in block B110), the process from block B106 to block B109 is executed, and thereby the main screen image rendered on the sub-screen is updated.

When the image rendered on the main screen has not been updated (NO in block B110), the display event detection module 311 determines whether the rendering of the operation image is to be terminated (block B111). For example, when the screen of the external display device 1 is switched to the sub-screen or the connection between the external display device 1 and the computer 10 has been released (“disconnection”), the display event detection module 311 terminates the rendering of the operation image.

When the rendering of the operation image is not terminated (NO in block B111), the process returns to block B110, and it is determined once again whether the main screen has been updated. On the other hand, when the rendering of the operation image is to be terminated (YES in block B111), the operation image display module 315 terminates the rendering of the operation image (block B112).

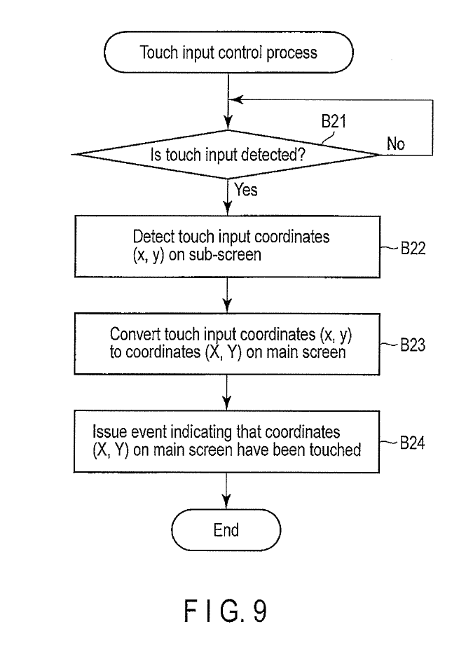

FIG. 9 illustrates an example of the procedure of a touch input control process which is executed by the computer 10. It is assumed that the screen of the external display device 1 is set to be the main screen, and the screen of the touch-screen display 17 (LCD 17A) is set to be the sub-screen. In addition, it is assumed that a screen image displayed on the main screen is displayed on the sub-screen.

To start with, the touch input detection module 321 determines whether a touch input using the touch panel 17B has been detected (block B21). The touch input indicates an operation of touching the touch panel 17B, and includes a drag input, a flick input, etc. When the touch input has not been detected (NO in block B21), the process returns to block B21, and it is determined once again whether the touch input has been detected.

When the touch input has been detected (YES in block B21), the touch input detection module 321 detects touch input coordinates (x, y) on the sub-screen (i.e. touch panel 17B) (block B22). Then, the coordinate conversion module 322 converts the detected touch input coordinates (x, y) to coordinates (X, Y) on the main screen (external display device 1) (block B23).

Subsequently, the input event generation module 323 issues an event indicating that the coordinates (X, Y) on the main screen have been touched (block B24). Responding to the issued event, the OS 201 and various programs, which are executed by the computer 10, execute processes corresponding to the event. For example, when the coordinates (X, Y) indicated in the issued event represent a position within a button displayed on the main screen, the function associated with the button is executed. In addition, for example, when the coordinates (X, Y) indicated in the issued event represent a position within a window displayed on the main screen, this window is set in the active state.

By the above-described screen image display control process and the touch input control process, either the LCD 17A in the touch-screen display 17 or the external display device 1 is set to be the operation target screen which is operated by the input using the touch panel 17B in the touch-screen display 17. Thereby, not only the screen displayed on the LCD 17 but also the screen displayed on the external display device 1 can be operated by using the touch panel 17B. In addition, when the external display device 1 is set to be the operation target screen, the screen image displayed on the external display device 1 is displayed on the screen of the LCD 17A in accordance with a predetermined operation. In this case, a touch input on the touch panel 17B is substituted for a touch input on the external display device 1, and an object displayed on the external display device 1 can intuitively be operated by the touch input using the touch panel 17B.

As has been described above, according to the present embodiment, when a first display (touch-screen display 17) including a touch panel and a second display (external display device 1), which is not provided with a touch panel, are connected, it is possible to support the operation of the second display using the touch panel in the first display. Specifically, the operation using the touch panel in the first display can be made to act on the second display. In addition, when the second display is set to be the operation target screen, an image corresponding to the image displayed on the second display is displayed on the first display. Thereby, the operation of the second display can intuitively be executed by using the touch panel.

All the procedures of the screen image display control process and the touch input control process according to this embodiment can be executed by software. Thus, the same advantageous effects as with the present embodiment can easily be obtained simply by installing a computer program, which executes the procedures of the screen image display control process and the touch input control process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus which comprises a touch-screen display comprising a touch panel and a first display and is connectable to a second display, the electronic apparatus comprising:
an operation screen switching module configured to set either the first display or the second display to be an operation target screen operated by an input using the touch panel; and
an input control module configured to operate the second display in accordance with the input using the touch panel when the second display is set to be the operation target screen.

2. The electronic apparatus of claim 1, further comprising a display control module configured to display a first image on the first display when the second display is set to be the operation target screen, the first image corresponding to a second image displayed on the second display.

3. The electronic apparatus of claim 2, wherein the display control module is configured to generate the first image by varying the second image based on a size of the first display, and to display the generated first image on the first display.

4. The electronic apparatus of claim 2, wherein the display control module is configured to display the first image on the first display in a transparent display manner.

5. The electronic apparatus of claim 2, wherein the second image comprises one or more windows, and the display control module is configured to enlarge a window of the one or more windows and to display the enlarged window on the first display when a position within the window has been designated.

6. The electronic apparatus of claim 2, wherein the input control module is configured to convert first coordinates within the first display to second coordinates within the second display and to issue an event indicating that the second coordinates have been designated, if the second display is set to be the operation target screen and the first coordinates have been designated by the input using the touch panel.

7. The electronic apparatus of claim 1, wherein the input control module is configured to convert first coordinates within the first display to second coordinates within the second display and to issue an event indicating that the second coordinates have been designated, if the second display is set to be the operation target screen and the first coordinates have been designated by the input using the touch panel.

8. The electronic apparatus of claim 1, wherein the operation screen switching module is configured to set either the first display or the second display to be the operation target screen in accordance with an operation by a user.

9. An operation support method of supporting an operation on an electronic apparatus which comprises a touch-screen display comprising a touch panel and a first display and is connectable to a second display, the method comprising:
setting either the first display or the second display to be an operation target screen operated by an input using the touch panel; and
operating the second display in accordance with the input using the touch panel when the second display is set to be the operation target screen.

10. The operation support method of claim 9, further comprising displaying a first image on the first display when the second display is set to be the operation target screen, the first image corresponding to a second image displayed on the second display.

11. A non-transitory computer readable medium having stored thereon a computer program for supporting an operation on a computer which comprises a touch-screen display comprising a touch panel and a first display and is connectable to a second display, the computer program being configured to cause the computer to:
set either the first display or the second display to be an operation target screen operated by an input using the touch panel; and
operate the second display in accordance with the input using the touch panel when the second display is set to be the operation target screen.

12. The non-transitory computer readable medium of claim 11, wherein the computer program is configured to further cause the computer to display a first image on the first display when the second display is set to be the operation target screen, the first image corresponding to a second image displayed on the second display.
